(19) United States
(12) Patent Application Publication
(10) Pub. No.: US 2010/0070568 A1
(43) Pub. Date: Mar. 18, 2010

(54) FUNCTION UNIT GENERATING APPARATUS AND METHOD FOR SOFTWARE STREAMING

(75) Inventors: Jeong Min Shim, Daejeon (KR); Won Young Kim, Daejeon (KR); Wan Choi, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/513,294

(22) PCT Filed: Oct. 30, 2007
(86) PCT No.: PCT/KR07/05378

§ 371 Date: May 1, 2009

(30) Foreign Application Priority Data
Nov. 1, 2006 (KR) 10-2006-0107419

(51) Int. Cl. G06F 9/445; G06F 15/16

(52) U.S. Cl. 709/203; 717/178; 709/231

(57) ABSTRACT

A function unit generating apparatus and method for streaming software in a function unit are provided. The function unit generating apparatus includes a function filter, a page collector, and a software controller. The function filter generates function information about a function by analyzing events generated when the function of software is performed. The page collector creates page information about the function by collecting pages required for performing the function. The software controller executes each function of the software and creates a function unit for the function by mapping the function information and the page information, which are generated when the function is executed.

### TECHNICAL FIELD

The present invention relates to a function unit generating apparatus for software streaming and, more particularly, to a function unit generating apparatus and method for streaming software in a function unit.

This work was supported by the IT R&D program of MIC/IITA [2005-S-007-02, A Development of Open Software Based On-Demand Officeware Deployment Technologies].

### BACKGROUND ART

A software streaming service is a service enabling a client terminal to execute software located in a server without downloading the software from the server or without installing the software at the client terminal.

In order to provide such a software streaming service, the client terminal and the server need to perform a pre-process for corresponding software. That is, the client terminal and the server collect a list of software files and divide software files into pages used in a corresponding operation system.

However, a conventional client terminal requests a server to transmit pages only requested by an operating system in real time without analyzing an internal structure of software, the object of streaming. Then, a conventional server selects the requested pages from the pages of the software, which was divided in the pre-process, and transmits the selected pages to the client terminal.

FIG. 1 is a flowchart illustrating a software streaming method of a client terminal according to the related art.

Referring to FIG. 1, when an initialization process is performed for executing software by a user at step S11, the conventional client terminal detects pages required by the operating system and requests a conventional server to transmit the corresponding pages at step S12.

Then, the server transmits the requested pages to the client terminal, and the client terminal 100 receives the transmitted pages from the server. After receiving the pages, the client terminal repeatedly performs the steps S12 and S13 until there are no more pages required by the operation system at step S13.

If there are no more pages required by the operation system, the conventional client terminal confirms that all necessary pages for initializing software are received and initializes the software based on the received pages at step S14.

After initializing, if a user selects one of functions of the software at step S15, the client terminal detects pages required by the operating system to perform the selected function at step S16, and requests the server to transmit the required pages at step S17.

After the serve 200 the requested pages, the client terminal repeatedly perform the steps S17 and S18 until there is no more page required for the operation system to perform the selected function at step S18.

If there are no more pages required for the operation system to perform the selected function at step S18, the client terminal confirms that all pages to perform the selected function are received. Then, the client terminal performs the selected function of the software based on the received pages at step S16.

As described above, the conventional software streaming method allows the conventional client terminal to use the software in the server like as that installed in the client terminal.

According to the conventional software streaming method, it is, however, impossible to detect pages required for a predetermined function before the predetermined function of the software is executed.

That is, the predetermined function of the software is required to be executed to detect the related pages and request the server to transmit the related pages for the pre-determined function. Therefore, the requesting and receiving steps S13 to S14 or S17 to S18 need to be repeatedly performed as many as the number of required pages in the conventional software streaming method.

For example, if the operating system of the client terminal requires five execution pages and one data page to perform a print function, the requesting and receiving steps S14 to S15 need to be performed six times between the client terminal and the server.

### DISCLOSURE OF INVENTION

### Technical Problem

Therefore, the conventional software streaming method has disadvantages of a long service loading time and service interruption. That is, the service loading time increases by performing the requesting and receiving steps, repeatedly, and the related software streaming service may be interrupted if the network problem is arisen by improperly managing function information for streamed data.

### Technical Solution

An aspect of the present invention is to provide a function unit generating apparatus and method for software streaming to stream all pages of a predetermined function at once, to reduce a service loading time of software in a client terminal, and to stably support corresponding software to execute when a related network is malfunctioned.

According to an aspect of the invention, the invention provides a function unit generating apparatus includes a function filter, a page collector, and a software controller. The function filter generates function information about a function by analyzing events generated when the function of software is performed. The page collector creates page information about the function by collecting pages required for performing the function. The software controller executes each function of the software and creates a function unit for the function by mapping the function information and the page information, which are generated when the function is executed.

According to another aspect of the invention, the invention provides a function unit generating method for streaming software. In the function unit generating method, an initialization unit is generated by initializing software and pages required for initializing the software are comprehended. Then, a function of the software is selected and a function executing unit is generated for the selected function by comprehending pages required for performing the selected function and events generated by the function.

According to still another aspect of the invention, the invention provides a method for streaming software to a client terminal remotely accessing a server. In the method, an initialization unit is created by comprehending pages required for initializing the software, and a function executing unit is generated for the selected function by comprehending pages required for performing the selected function and events generated by the function. Then, pages required for initializing the software are received from the server according to the initialization unit through streaming when the initialization of the software is re-performed. After receiving the pages, pages required for performing a selected function are received from the server according to a function executing unit for the selected function if a function of the software is selected.

### Advantageous Effects

A function unit generating apparatus and method for software streaming according to the certain embodiment of the present invention has following advantageous effects.

In the function unit generating apparatus and method for software streaming according to the certain embodiment of the present invention, the pages of each function in software are detected before corresponding pages are streamed in a function unit. Therefore, a software streaming service can be provided in high speed.

In the function unit generating apparatus and method for software streaming according to the certain embodiment of the present invention, each function of software and the pages of a corresponding function can be detected and managed. Therefore, the streaming service can be provided using the previously streamed pages although the network is malfunctioned.

Since a function used by a user can be accurately comprehended, various software streaming services can be provided, such as charging a user by a function used by a user.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a flowchart illustrating a software streaming method of a client terminal according to the related art;

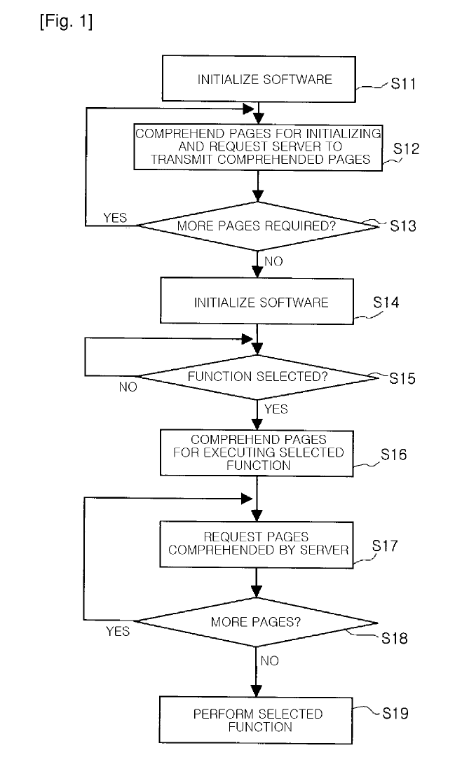

FIG. 2 is a block diagram illustrating a function unit generating apparatus for software streaming according to an embodiment of the present invention;

FIG. 3 is a flowchart illustrating a function unit generating method for software streaming according to an embodiment of the present invention;

FIG. 4 is a diagram illustrating a function formed of pages according to an embodiment of the present invention; and

FIG. 5 is a flowchart illustrating a software streaming method of a client terminal using a function unit generating method of FIG. 3;

FIG. 6 is a diagram illustrating a software formed of files to generate a function unit according to an embodiment of the present invention; and

FIG. 7 is a diagram illustrating a function unit of software according to an embodiment of the present invention.

### BEST MODE FOR CARRYING OUT THE INVENTION

Hereinafter, preferred embodiments of the present invention will be described in detail with reference to the attached drawings. In order to clearly describe the present invention, descriptions of well-known functions and elements are omitted.

Also, like numeral references denote like elements through the accompanying drawings.

Hereinafter, a function unit generating apparatus for software streaming according to an embodiment of the present invention will be described with reference to accompanying drawings.

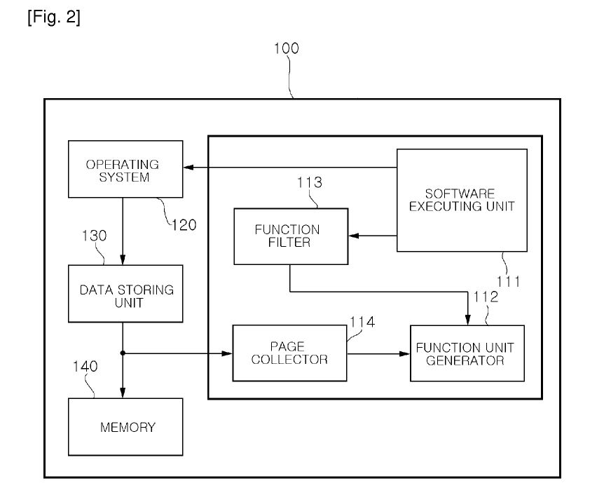

FIG. 2 is a block diagram illustrating a function unit generating apparatus for software streaming according to an embodiment of the present invention.

Referring to FIG. 2, the function unit generating apparatus 100 includes a software manager 110, an operating system 120, a data storing unit 130, and a memory 140. The software manager 110 includes a software executing unit 111, a function unit generator 112, a function filter 113 and a page collector 114.

The software executing unit 111 detects a request from a user and executes each function of the software based on the pages loaded in the memory 140.

The function unit generator 112 generates a function unit corresponding to each function by mapping the page information collected through the page collector 114 to the function information obtained through the function filter 113 when the software executing unit 111 initially executes each function of the software.

Preferably, the function unit is generally divided into two unit function, an initial unit, and a function executing unit. The initialization unit includes information for initializing the software, and the function executing unit including information about pages for executing each function.

The function filter 113 collects function information about each function by comprehending and analyzing events called or executed by the software executing unit 111 when the software executing unit 111 executes each function of software.

The page collector 114 collects page information about the pages of each function by comprehending and analyzing the pages loaded in the memory 140 from the data storing unit 130 when the software executing unit 111 executes each function of the software.

The operating system 120 obtains the pages required to perform each function from the data storing unit 130 when a predetermined function of the software is performed and loads the obtained pages on the memory 140.

The data storing unit 130 divides constitutional files required for executing the software into pages and stores the pages in order to enable the operating system 120 to recognize the software.

The memory 140 loads pages transmitted from the data storing unit 130 in response to the operating system. The memory 140 also deletes the loaded pages in response to the function unit generator 112.

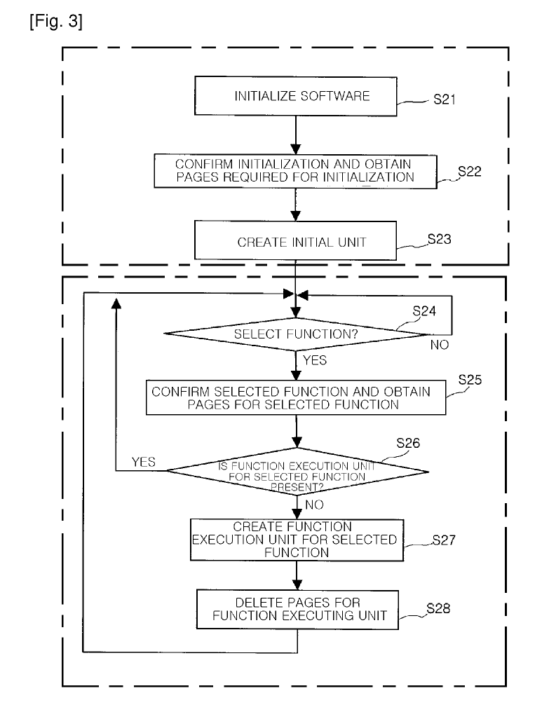

FIG. 3 is a flowchart illustrating a function unit generating method for software streaming according to an embodiment of the present invention.

When predetermined software is selected and executed, the initialization process of the selected software is performed at step S21. The function filter 113 confirms that the initialization of the software is performed and creates the function information to inform that the selected software is initialized. The page collector 114 collects the page information by comprehending pages obtained from the data storing unit 130 and loaded on the memory 140 for initializing the software at step S22.

The function unit generator 112 generates an initialize unit for initializing the software by mapping the page information to the function information obtained by the function filter 113 at step S23.

If the initialization unit is generated through the steps S21 to S23, the software sustains a waiting state and monitors whether a predetermined function is selected by a user or not at step S24.

If a predetermined function is selected by a user, the page collector 114 collects page information by detecting pages required for performing the selected function, and the function filter 113 obtains function information to inform the selected function is by detecting and analyzing events called and executed as the selected function is performed at step S25.

The function unit generator 112 searches the previously generated function executing units and determines whether a function executing unit having the function information obtained through the function filter 113 is present or not at step S26.

If the function executing unit having function information obtained through the function filter 113 is present at step S26, the function unit generator 112 confirms that the function executing unit for the selected function had been already created. Then, the step S24 is performed to create a function executing unit for new function.

On the contrary, if the function executing unit having function information obtained through the function filter 113 is not present at step S26, the function unit generator 112 confirms that the function executing unit for the selected function was not created. Then, the function unit generator 112 creates a function executing unit for a selected function by mapping the obtained function information and the page information at step S27.

After generating the function executing unit at the step S27, the function unit generator 112 deletes all pages loaded on the memory 140 except pages corresponding to the initial unit. That is, the function unit generator 112 deletes pages corresponding to the currently created function executing unit at step S28. Then, the function unit generator 112 further creates the function executing units for new function by re-performing the step S24.

In order to collect accurate page information mutually accessed by various functions, the function unit generator 112 deletes all pages loaded for generating a function executing unit.

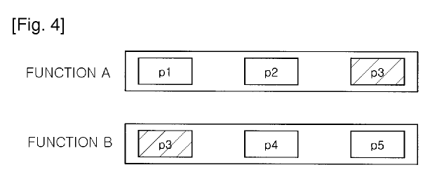

For example, it assumes that a function A includes pages p1, p2, and p3, and a function B includes page P3, p4, and p5 as shown in FIG. 4. After generating function units for the function A, the pages p1, p2, and p3 are loaded on the memory 140. Then, if the function B is executed, the page collector 114 cannot detect the information about the page P3 because the p3 is already loaded on the memory. Therefore, after generating function units for each function, it requires the pages for a corresponding function to delete from the memory 140.

The function unit generating apparatus 100 may be realized as a local system in a client terminal or as a supplementary device physically separated from the client terminal.

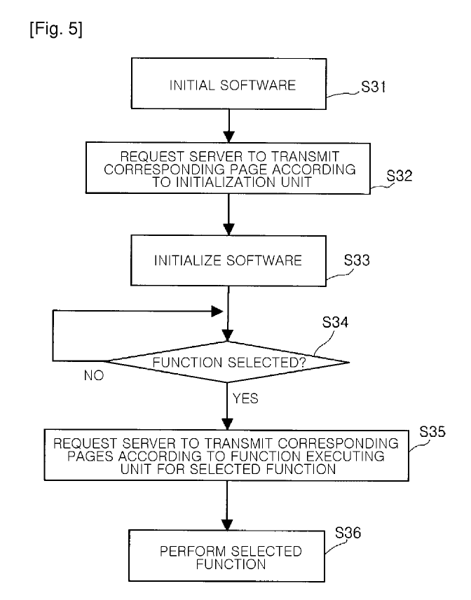

FIG. 5 is a software streaming method of a client terminal using a function unit generating method shown in FIG. 3.

When a user selects an operation for executing software, the initialization operation of corresponding software is requested at step S31. Then, the client terminal 100 detects pages required for initializing software with reference to the initialization unit and requests the server 200 to transmit the required pages at step S32.

If the server 200 transmits the requested pages in response to the requested from the client terminal 100, the client terminal 100 receives the requested pages from the server 200 and performs the initialization process of the software based on the received pages at step S33.

When a user selects a predetermined function at step S34, the client terminal 100 requests the server 200 to transmit pages to perform the selected function with reference to a function unit corresponding to the selected function at step S35.

Then, the server 200 obtains and transmits pages for performing the selected function. The client terminal 100 receives the pages and performs the selected function of the software requested by the user based on the received pages at step S36.

As described above, the unit function generating method according to the present embodiment allows the client terminal to use software installed in the server like as software installed in a local system thereof. Also, the client terminal is allowed to comprehend pages to perform the selected function in advance.

If a predetermined function of software is performed, pages required for performing corresponding function are comprehended at once, and the necessary pages can be received through one time request and receiving steps S31 and S35.

For example, although the operating system of the client terminal requests five execution pages and one data page to perform a print function, the client terminal can comprehend corresponding pages at once and can receive the pages through one time requesting and receiving step S35.

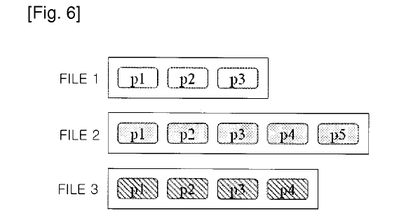

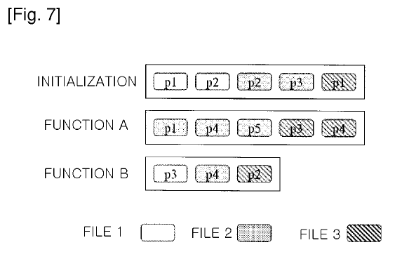

FIG. 6 is a diagram illustrating the files of software to generate a function unit according to an embodiment of the present invention, and FIG. 7 is a diagram illustrating a function unit of software according to an embodiment of the present invention.

As shown in FIG. 6, the software includes the first file 1, the second file 2, and the third file 3. The first file 1 includes three pages p1, p2, and p3. The second file 2 includes five pages p1, p2, p3, p4, and p5. The third file 3 includes four pages p1, p2, p3, and p4.

On the contrary, the function unit of the software is divided into an initialization unit and a function executing unit. The initialization unit includes the first and second pages p1 and p2 of the first file 1, the second page p2 of the second file 2, and the first and third pages p1 and p3 of the third file 3. The function executing unit of the function A includes the first, fourth, and fifth pages p1, p4, and p5 of the second file 2, and the third and fourth pages p3 and p4 of the second file 2, and the third and fourth pages p3 and p4 f the third file 3. The function executing unit of the function B includes a third page p3 of a first file 1 and a second page p2 of a third file 3.

The client terminal according to the present embodiment is provided only with the necessary pages from the server with reference to the function unit regardless constitutional files of the software when the predetermined function of the software is performed.

For example, when the function A of the software is performed, the first, fourth, and fifth pages p1, p4, and p5 of the second file 2, and the third and fourth pages p3 and p4 of the third file 3 are provided at once. When the function B of the software is performed, the third page p3 of the first file 1 and the second page p2 of the third file 3 are provided at once.

Although the preferred embodiments of the present invention have been disclosed for illustrative purpose, those skilled in the art will appreciate that various modifications, additions and substitutions can be made without departing from the scope and spirit of the invention as defined in the accompanying claims.

1. A function unit generating apparatus comprising:
a function filter for generating function information about a function by analyzing events generated when the function of software is performed;
a page collector for generating page information about the function by collecting pages required for performing the function; and
a software controller for executing each function of the software, and generating a function unit for the function by mapping the function information and the page information, which are generated when the function is executed.

2. The function unit generating apparatus according to claim 1, wherein the software controller comprises:
a software executing unit for initializing the software and performing each function of the software; and
a function unit generator for generating an initialization unit by mapping the function information and the page information, which are generated when initializing the software, and generating the function executing unit for the function by mapping the function information and the page information, which are generated when the function is performed.

3. The function unit generating apparatus according to claim 2, wherein the function unit generator deletes the pages collected to create the function executing unit after completely generating the function executing unit.

4. The function unit generating apparatus according to claim 2, wherein the function unit generator generates the initialization unit and the function executing unit one time only.

5. The function unit generating apparatus according to claim 1, wherein the function unit generating apparatus further comprises:
a data storing unit for dividing constitutional files of the software into pages and storing the pages of the constitutional files of the software;
a memory for loading the pages transmitted from the data storing unit; and
an operating system for obtaining the pages required for executing a function of the software from the data storing unit and transmitting the obtained pages to the memory.

6. A function unit generating method for streaming software comprising:
generating an initialization unit by initializing software and comprehending pages required for initializing the software; and
selecting a function of the software and generating a function executing unit for the selected function by comprehending pages required for performing the selected function and events generated by the function.

7. The function unit generating method according to claim 6, wherein the step of generating an initialization unit comprises:
generating function information for informing that the initialization of the software is performed when the initialization of the software is performed;
collecting page information by comprehending pages required to perform the initialization and
generating the initialization unit by mapping the page information to the function information.

8. The function unit generating method according to claim 6, wherein the step of generating a function executing unit comprises:
collecting page information by comprehending pages required for a selected function of the software when the function is selected;
generating the function information by comprehending events generated by the selected function; and
generating a function executing unit for the selected function by mapping the page information to the function information.

9. The function unit generating method according to claim 8, wherein the step of generating a function executing unit further comprises deleting the collected pages for generating the function executing unit after completely generating the function executing unit for the selected function.

10. A method for streaming software to a client terminal remotely accessing a server, the method comprising:
generating an initialization unit by comprehending pages required for initializing the software, and generating a function executing unit for the selected function by comprehending pages required for performing the selected function and events generated by the function
receiving pages required for initializing the software from the server according to the initialization unit through streaming when the initialization of the software is re-performed and
receiving pages required for performing a selected function from the server according to a function executing unit for the selected function if a function of the software is selected.

11. The method according to claim 10, wherein the step of generating a function executing unit comprises:
generating the initialization unit by comprehending pages to initialize the software; and
generating the function executing unit for the selected function by comprehending events generated by the selected function and pages for performing the selected function.

12. The method according to claim 11, wherein the step of generating the initialization unit comprises:
generating function information for informing the initialization of the software is performed when the initialization of the software is performed;
collecting page information by comprehending pages required for initializing the software; and
generating the initialization unit by mapping the page information to the function information.

13. The method according to claim 11, wherein the step of generating a function executing unit comprises:
collecting the page information by comprehending pages for executing a selected function if the function of the software is selected;
generating a function information by comprehending events generated by the selected function; and
generating the function executing unit for the selected function by mapping the page information to the function information.

14. The method according to claim 11, wherein the step of generating a function executing unit further comprises deleting the pages collected for generating the function executing unit if the function executing unit for the selected function is completely generated.
